(19) United States
(12) Patent Application Publication
(10) Pub. No.: US 2019/0334366 A1
(43) Pub. Date: Oct. 31, 2019

(54) ANALOG PING DETECTION FOR A WIRELESS CHARGING RECEIVER

(71) Applicant: STMicroelectronics Design and Application S.R.O., Prague (CZ)

(72) Inventors: Karel BLAHA, Plzen (CZ); Martin DRINOVSKY, Horomerice (CZ)

(73) Assignee: STMicroelectronics Design and Application S.R.O., Prague (CZ)

(21) Appl. No.: 15/964,793

(22) Filed: Apr. 27, 2018

(51) Int. Cl. H02J 7/02; H02J 50/05; H02J 50/80

(52) U.S. Cl. CPC H02J 7/025; H02J 50/80; H02J 50/05

(57) ABSTRACT

An analog ping signal that is present at a secondary coil of a power receiving device operating within a wireless power transmission system is detected. The detection circuit includes a DC blocking circuit having an input directly connected to a terminal of the secondary coil. A comparator circuit has an input coupled to an output of the DC blocking circuit. A timer circuit is reset by a signal output by the comparator circuit to assert a ping detect signal in response to a resetting of the timer circuit. The ping detect signal is deasserted in response to a timing out of the timer circuit.

### TECHNICAL FIELD

The present disclosure relates to wireless power transfer between a power transmitter device (also referred to in the art as a charging station) and a power receiving device (also referred to in the art as a portable device). In particular, the present disclosure relates to the detection by the power receiving device of an analog ping signal sent by the power transmitter device for the purpose of triggering the power receiving device to wake up from sleep mode.

### BACKGROUND

Wireless power transmission is of considerable interest to consumers as a way to charge portable devices without the need to make a hard-wired connection to the charging station. The Wireless Power Consortium (WPC) has developed a standard that defines interoperability between power transmitter devices and power receiving devices. The WPC standard defines the type of inductive coupling (for example, coil configuration) and the communications protocol to be used for low-power wireless devices arranged in a configuration for wireless power transmission.

FIG. 1 is a block diagram of a system supporting wireless power transfer. The power transmitter device 10 is inductively coupled to the power receiving device 12. Power is transferred from the power transmitter device 10 towards the power receiving device 12, and data is communicated from the power receiving device 12 towards the power transmitter device 10. The power receiving device 12 utilizes the received power to charge a rechargeable power storage device, such as a battery, so that the power receiving device 12 can be operated in a portable manner. As an example, the power receiving device 12 may comprise a cellular telephone and the power transmitter device 10 may comprise a wireless charging station.

The power transmitter device 10 includes a primary coil 20 that is used to transfer power to a secondary coil 30 associated with the power receiving device 12. A power supply 22 supplies a voltage, for example, a DC voltage, to a driver circuit 24 having output terminals coupled to terminals of the primary coil 20. A control circuit 26 generates control signals to control operation of the driver circuit 24 pass an AC current with a variable frequency through the primary coil 20 and generate a power signal. A sensing circuit 28 has an input coupled to the primary coil 20 to sense and demodulate data signaling induced on the primary coil 20 by the power receiving device 12. The sensed data is communicated to the control circuit 26. The power receiving device 12 includes a rectification circuit 32 having input terminals coupled to terminals of the secondary coil 30 which is inductively coupled to the primary coil 20. The rectification circuit 32 operates to rectify the power signal transmitted from the power transmitter device 10 and produce an unregulated supply voltage. A voltage conditioning circuit 34, for example, a low drop-out voltage regulator, generates a regulated supply voltage from the unregulated supply voltage, with that regulated supply voltage used to power a control circuit 36 and charge a battery 38. The control circuit 36 has an output coupled to the secondary coil 30 and configured to induce the data signaling for communication back to the power transmitter device 10 using a backscatter modulation technique as well known in the art where the secondary coil 30 is loaded in response to the data signaling which causes corresponding change current draw at power transmitter device 10. The change in current draw is detected by the sensing circuit 28 coupled to the primary coil 20.

In accordance with the WPC standard, the control circuit 26 of the power transmitter device 10 actuates the driver circuit 24 to periodically transmit an analog ping signal over the wireless interface towards the power receiving device 12. The purpose of this analog ping signal communication is to detect whether any power receiving device 12 is present. In response to receipt and detection of the analog ping signal, the control circuit 36 of the power receiving device 12 induces the data signaling to be communicated back to the power transmitter device 10. This data signaling may, for example, include information which identifies the power receiving device 12 to the power transmitter device 10 as a WPC standard compliant device as well as provides configuration information (comprising, for example, signal strength information, power request information, error information, etc.).

In some instances, the processing unit within the power receiving device 12 (for example, associated with the control circuit 36) is operating in a low power or sleep mode when brought into sufficient proximity of the power transmitter device 10 where power transfer is possible. In such a case, it is important for the power receiving device 12 to operate in a manner which permits detection of the analog ping signal for the purpose of causing the processing unit of the power receiving device 12 to wake from sleep mode. In a known solution to the issue of detecting the analog ping signal, a sense circuit 40 is configured with an input coupled to the unregulated supply voltage output from the rectification circuit 32.

The specific signal form and shape for the analog ping signal is not specified by the WPC standard. Thus, each manufacturer is free to select a desired signal form and shape and, not surprisingly, there exists a wide variety of analog ping signal forms and shapes as shown in FIGS. 2A-2F. It will be noted that the analog ping signals exhibit, for example, different amplitudes and repetition rates. Unfortunately, sensing at the unregulated supply voltage output from the rectification circuit 32 has proven to be an insufficiently sensitive means for analog ping signal detection when dealing with analog ping signals that exhibit such a wide variety of forms and shapes.

There is a need in the art for an improved solution for analog ping signal detection in a power receiving device 12 used in connection with a system supporting wireless power transfer.

### SUMMARY

In an embodiment, a circuit is configured to detect an analog ping signal present at a secondary coil of a power receiving device operating within a wireless power transmission system. The circuit comprises: a DC blocking circuit having an input directly connected to a terminal of the secondary coil; a comparator circuit having an input coupled to an output of the DC blocking circuit; and a timer circuit reset by a signal output by the comparator circuit to assert a ping detect signal in response to a resetting of the timer circuit and deassert the ping detect signal in response to a timing out of the timer circuit.

In an embodiment, a method is provided for detecting an analog ping signal present at a secondary coil of a power receiving device operating within a wireless power transmission system. The method comprises: sensing an AC signal at a terminal of the secondary coil; comparing the AC signal to a threshold; and resetting a timer circuit if the comparison indicates that the AC signal exceeds the threshold and asserting a ping detect signal in response to the resetting of the timer circuit; and allowing the timer circuit to time out if the comparison indicates that the AC signal does not exceed the threshold and deasserting the pin detect signal in response to the timing out of the timer circuit.

### BRIEF DESCRIPTION OF THE DRAWINGS

The foregoing and other features and advantages will be discussed in detail in the following non-limiting description of specific embodiments in connection with the following illustrations wherein:

FIG. 1 is a block diagram of a system supporting wireless power transfer;

FIGS. 2A-2F illustrate example analog ping signal waveforms;

FIG. 3 is a block diagram of a power receiving device having an improved analog ping signal detection circuit; and

FIG. 4 is a circuit diagram of an analog ping signal sensing circuit.

### DETAILED DESCRIPTION

The same elements have been designated with the same reference numerals in the various drawings and, further, the various drawings are not to scale. For clarity, only those elements which are useful to the understanding of the described embodiments have been shown and are detailed.

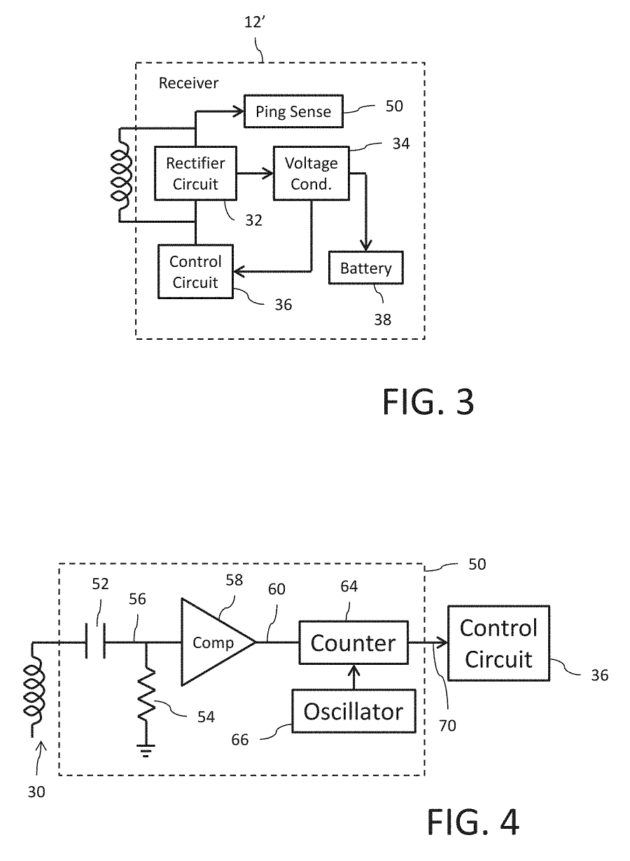

Reference is now made to FIG. 3 which illustrates a block diagram of a power receiving device 12′ having an improved analog ping signal detection circuit 50. The power receiving device 12′ includes a rectification circuit 32 having input terminals coupled to terminals of a secondary coil 30 that may be inductively coupled to a power transmitter device in connection with a wireless power transmission system. The rectification circuit 32 operates to rectify a power signal transmitted from the power transmitter device to produce an unregulated supply voltage. A voltage conditioning circuit 34, for example, a low drop-out voltage regulator, generates a regulated supply voltage from the unregulated supply voltage, with that regulated supply voltage used to power a control circuit 36 and charge a battery 38. The control circuit 36 has an output coupled to the secondary coil 30 and configured to induce the data signaling for communication back to the power transmitter device using a backscatter modulation technique as well known in the art.

In accordance with the WPC standard, the power transmitter device will periodically transmit an analog ping signal over the wireless interface towards the power receiving device 12′. The purpose of this analog ping signal communication is to detect whether any power receiving device 12′ is present. The power receiving device 12′ includes a sense circuit 50 that is configured with an input coupled to a terminal of the secondary coil 30, the sense circuit 50 accordingly operating to receive the power signal passing through the secondary coil 30. The sense circuit 50 operates to detect the analog ping signal and generate a control signal which causes the power receiving device 12′ to respond in accordance with the WPC standard by supplying data signaling transmitted toward the power transmitter device. This data signaling may, for example, include information which identifies the power receiving device 12 to the power transmitter device 10 as a WPC standard compliant device as well as provide configuration information (comprising, for example, signal strength information, power request information, error information, etc.). Additionally, the control signal output by the sense circuit 50 may function to cause processing circuitry within the power receiving device 12′ to wake from sleep mode. For example, in the context of a power receiving device 12′ that is a mobile or portable device like a cellular telephone, the generated control signal will cause the processor of the mobile or portable device to wake up from a low power or sleep mode of operation.

Reference is now made to FIG. 4 which shows a circuit diagram of the sense circuit 50. A capacitor 52 is coupled in series with a resistor 54 between the terminal of the secondary coil 30 and a supply reference node (for example, ground). It will be noted that a terminal of the capacitor in an embodiment is directly connected to the terminal of the secondary coil 30, and more generally speaking the sense circuit 50 is configured to be able to directly sense the current and/or voltage at the secondary coil. A tap node 56 between the series coupling of the capacitor 52 and resistor 54 is coupled to an input of a voltage comparator 58. The capacitor 52 functions as a DC blocking capacitor, so only the AC component of the power signal passing through the secondary coil 30 is applied to the input of the voltage comparator 58. The analog ping signal contributes to the AC component which is then compared to the threshold voltage of the voltage comparator 58. A comparator output signal 60 is asserted each time the sensed AC component exceeds the threshold voltage. Thus, the comparator output signal 60 is asserted in response to the presence of the analog ping signal at the secondary coil 30. In an embodiment, the threshold voltage may comprise approximately 1 V. A counter circuit 64 has a reset input coupled to receive the comparator output signal 60 and a clock input coupled to receive a clock signal output from an oscillator circuit 66. The counter circuit 64 is configured as a watchdog timer that is reset with each assertion of the comparator output signal 60 and when reset operates to assert the ping detect signal 70. In the absence of a comparator output signal 60 assertion (i.e., in the absence of the detection of the analog ping signal), the counter circuit 64 will count down in response to the clock signal and eventually time out, at which point the ping detect signal 70 is deasserted. The ping detect signal 70 is applied to the control circuit 36 at an interrupt port which is configured to provide a wake up functionality. The processor of the control circuit 36 responds to the interrupt due to assertion of the ping detect signal 70 by, for example, waking from a sleep mode. The assertion of the ping detect signal 70 further drives the operation of the power receiving device 12′ to respond in accordance with the WPC standard by supplying data signaling transmitted toward the power transmitter device. This data signaling may, for example, include information which identifies the power receiving device 12 to the power transmitter device 10 as a WPC standard compliant device as well as provide configuration information (comprising, for example, signal strength information, power request information, error information, etc.).

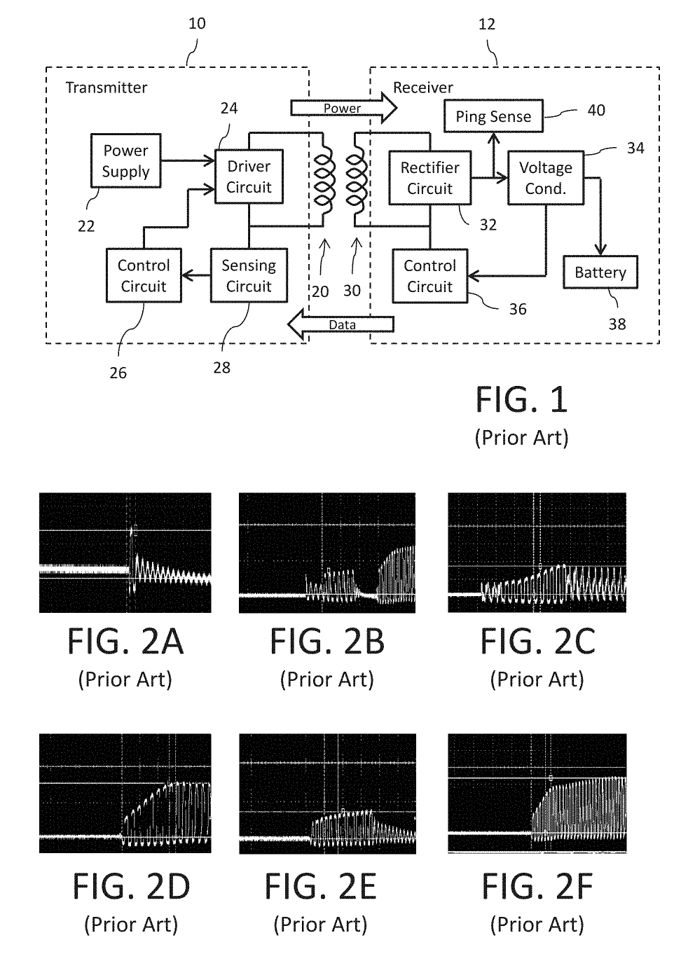

An advantage of the sense circuit 50 over the sense circuit 40 (of FIG. 1) is that the sense circuit 50 provides for a robust detection of a wide variety of analog ping signal forms and shapes as shown, for example, by FIGS. 2A-2F. Analog ping signals of different amplitudes and repetition rates are detectable using the sense circuit 50 whose input is directly connected to one terminal of the secondary coil 30 of the power receiving device 12′. The connection of the ping detect signal 70 to an interrupt of the processor for the control circuit 36 effectively enables the detection of the analog ping signal to drive an operation to wake the processor from sleep mode.

Alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. A circuit configured to detect an analog ping signal present at a secondary coil of a power receiving device operating within a wireless power transmission system, comprising:
a DC blocking circuit having an input directly connected to a terminal of the secondary coil;
a comparator circuit having an input coupled to an output of the DC blocking circuit; and
a timer circuit reset by a signal output by the comparator circuit to assert a ping detect signal in response to a resetting of the timer circuit and deassert the ping detect signal in response to a timing out of the timer circuit.

2. The circuit of claim 1, wherein the DC blocking circuit comprises a DC blocking capacitor having a terminal directly connected to said terminal of the secondary coil.

3. The circuit of claim 1, wherein said timer circuit is a watchdog timer.

4. The circuit of claim 1, wherein the DC blocking circuit passes an AC signal that is indicative of presence of the analog ping signal at the secondary coil.

5. The circuit of claim 4, wherein the comparator circuit is configured to compare the AC signal to a threshold voltage and cause the resetting of the timer circuit when the AC signal exceeds the threshold voltage.

6. The circuit of claim 1, further comprising a control circuit with a processor having an interrupt configured to receive the ping detect signal.

7. The circuit of claim 6, wherein the processor is configured to respond to assertion of the ping detect signal at the interrupt by waking up from a sleep mode of operation.

8. The circuit of claim 6, wherein the processor is configured to respond to assertion of the ping detect signal at the interrupt by changing from a low power mode of operation.

9. A method for detecting an analog ping signal present at a secondary coil of a power receiving device operating within a wireless power transmission system, comprising:
sensing an AC signal at a terminal of the secondary coil;
comparing the AC signal to a threshold; and
resetting a timer circuit if the comparison indicates that the AC signal exceeds the threshold and asserting a ping detect signal in response to the resetting of the timer circuit;
allowing the timer circuit to time out if the comparison indicates that the AC signal does not exceed the threshold and deasserting the pin detect signal in response to the timing out of the timer circuit.

10. The method of claim 9, wherein said timer circuit is a watchdog timer.

11. The method of claim 9, wherein the AC signal is indicative of presence of the analog ping signal at the secondary coil.

12. The method of claim 11, wherein comparing comprises comparing the AC signal to a threshold voltage and generating a timer reset signal when the AC signal exceeds the threshold voltage.

13. The method of claim 9, applying the ping detect signal to an interrupt of a processor for a control circuit.

14. The method of claim 13, further comprising respond to assertion of the ping detect signal at the interrupt by waking up the processor from a sleep mode of operation.

15. The method of claim 13, further comprising responding to assertion of the ping detect signal at the interrupt by changing from a low power mode of operation.
